(19) United States
(12) Patent Application Publication
(10) Pub. No.: US 2017/0325134 A1
(43) Pub. Date: Nov. 9, 2017

(54) METHOD AND APPARATUS FOR CONNECTING A MOBILE DEVICE TO A PAY-FOR-USAGE COMMUNICATION NETWORK

(71) Applicants: Tao WAN, Ottawa (CA); Peter ASHWOOD-SMITH, Gatineau (CA)

(72) Inventors: Tao WAN, Ottawa (CA); Peter ASHWOOD-SMITH, Gatineau (CA)

(73) Assignee: Huawei Technologies Co., Ltd., Shenzhen (CN)

(21) Appl. No.: 15/297,799

(22) Filed: Oct. 19, 2016

Related U.S. Application Data
(60) Provisional application No. 62/331,842, filed on May 4, 2016.

(51) Int. Cl. H04W 36/00; H04W 48/16; H04W 12/04; H04M 15/00; H04W 36/14; H04B 1/3816; H04W 88/06

(52) U.S. Cl. CPC H04W 36/0055; H04W 36/14; H04W 48/16; H04B 1/3816; H04W 12/04; H04M 15/58; H04W 88/06

(57) ABSTRACT

A method and apparatus for connecting/attaching a mobile device to a network. Service information, such as pricing and plan information, associated with one or more networks is provided to a mobile device. The mobile device requests and receives configuration details for a selected one of the networks. The configuration details can include identity information such as is stored in a reprogrammable SIM, usable for connecting/attaching the mobile device to the selected network. The mobile device then registers and connects with the selected network based on the configuration details.

### CROSS REFERENCE TO RELATED APPLICATIONS

This application claims the benefit of priority to U.S. Provisional Patent Application Ser. No. 62/331,842, filed on May 4, 2016, the contents of which are incorporated herein by reference.

### FIELD OF THE INVENTION

The present invention pertains to the field of consumer wireless communication systems and in particular to a method and apparatus for connecting a mobile device to a pay-for-usage communication network.

### BACKGROUND

In mobile communication systems, users often subscribe to a mobile carrier for voice and data services. However, when the user equipment (UE) is out of the service area of the “home” carrier, the UE can obtain service by roaming on another network. Roaming is often very expensive.

In order to connect a UE to a current 3G or 4G network, such as a High Speed Packet Access (HSPA) or Long Term Evolution (LTE)) network, a user is typically required to obtain a Subscriber Identity Module (“SIM”) card programmed by an operator. The SIM card allows the user's UE to connect to the carrier's mobile network. Each SIM card is programmed with unique identification information unique, including an International Mobile Subscriber Identity (“IMSI”) code and a shared secret, for user Authentication and Key Agreement (“AKA”). Upon initialization, the UE will typically perform a scanning operation to identify the available mobile networks. The SIM card contains a list of networks that the UE should connect to. This list prioritizes the operator's network and then networks belonging to roaming partners. SIM card based user experience is generally considered an improvement over non-SIM card based user experiences because it allows a single UE to connect to multiple mobile networks by simply switching between SIM cards. In contrast, older, non-SIM card based, mobile phones were typically locked to a particular operator. Consequently, without the support of a SIM card, it was necessary for a user to purchase a UE from each operator in order to access each operator's network. With a SIM card, a user only needs to buy a SIM card from each operator (assuming the use of an unlocked device). User experience is improved in at least two aspects: 1) it is less costly to buy a SIM card than a mobile phone (the former costs a few dollars while the latter costs hundreds of dollars); and 2) it is easier to carry a single mobile phone with multiple SIM cards than carrying multiple mobile phones, as a SIM card is much smaller than a mobile phone.

While there is significant improvement in user experience with the introduction of SIM cards, it is still unsatisfactory in some respects. Roaming allows the UE to maintain the same phone number, but is typically expensive. The ability to be reachable by the same phone number is becoming less important as users are shifting from using the UE primarily for telephony services towards data services. The use of data services enables the use of Over The Top (OTT) applications and functions, allowing users to communicate without reliance upon telephony services. The rise in prominence of OTT services has increased the number of users that feel tied to a single number, especially when travelling. From a user perspective, a user is typically willing to purchase a SIM card (e.g., by visiting a store or kiosk), select a rate plan (typically based on the recommendation of a sales person) and insert the SIM into their mobile phone in their home area. When travelling, this is a cumbersome process and even finding a single point of sale may be challenging. This is a particular problem for frequent travelers who will need to travel with multiple SIM cards. Further, from an operator perspective, each SIM card has to be programmed with unique identity information and shared secrets that have to be managed securely for a large number of users, which can result in high overhead costs. Further, SIM cards have to be distributed to many stores and customer service representatives have to be trained for them to be able to provide technical support, resulting in significant amount of operational and labour costs. The conventional mechanisms for a subscriber to travel, involve either bearing the financial cost of roaming services, or the time-consuming, and possibly difficult, process of getting a new SIM.

Attempts have been made to address some aspects of user inconvenience arising from the use of SIM cards. For example, Apple™ made an attempt to provide an iPhone™ with a single SIM card capable of working with multiple operators that have established a prior relationship with Apple™. This approach has the drawback of limiting user selection to only those operators having a relationship with Apple™. Another attempt by Simless, Inc. is to provide a virtual SIM card, stored in a trusted execution environment (TEE) within the UE. This allows for a reprogrammable SIM (or vSIM) that can help to mitigate the inconvenience of physical SIM cards. Neither attempt has appropriately addressed the need for users to be able to conveniently switch between networks using a single UE.

Therefore there is a need for a method and apparatus for connecting a UE to a wireless communication network, and for allowing a user to switch between networks, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for connecting a mobile device, such as a UE, wireless handheld device, or the like, to a selected pay-for-usage wireless communication network, the connection providing communication services according to a selected service plan, and for allowing a user to switch between multiple such networks and/or service plans. Embodiments of the present invention therefore provide a flexible, convenient experience for end users and a potentially more flexible and/or cost effective operational practice (e.g., improved key management) for operators.

In accordance with an embodiment of the present invention, there is provided a method for connecting/attaching a mobile device to a network, the method comprising: wirelessly receiving, by the mobile device, engagement terms associated with one or more available networks in a vicinity of the mobile device; wirelessly transmitting, by the mobile device, a request for configuration details associated with a selected network of the available networks; wirelessly receiving, by the mobile device, configuration details transmitted in response to the request, the configuration details for use in configuring the mobile device for connecting/attaching the mobile device to the selected network; and initiating a registration and connection operation with the selected network based on the configuration details.

The method may further comprise programming an authentication storage module of the mobile device in accordance with the configuration details prior to the registration and connection operation. The authentication storage module may comprise one or more of: a microprocessor and a memory of the mobile device; and a reprogrammable subscriber identity module (SIM) of the mobile device.

In some embodiments, the configuration details comprise identification information for the mobile device, the identification information usable for registering the mobile device with the selected network, wherein the selected network is programmed to accept registration of the mobile device upon use of said identification information thereby.

The method may further comprise wirelessly transmitting one or more of: an indication of a selected service plan offered in association with the selected network; and payment information for use in paying for usage of the selected network by the mobile device.

In some embodiments, the engagement terms are indicative of one or more of: pricing information; available service plans; network operator identity; scope of network coverage; network type; network speed; and geographic coverage.

In accordance with an embodiment of the present invention, there is provided a mobile device comprising a processing section such as a microprocessor operatively coupled to an electronic memory, a wireless transmitter and a wireless receiver. The mobile device may also comprise a user interface such as a touchscreen, video display and keypad, or the like. The mobile device is configured to: receive, using the wireless receiver, engagement terms associated with one or more available networks in a vicinity of the mobile device; transmit, using the wireless transmitter, a request for configuration details associated with a selected network of the available networks; receive, using the wireless receiver, configuration details transmitted in response to the request, the configuration details for use in configuring the mobile device for connecting/attaching the mobile device to the selected network; and initiate a registration and connection operation, using the wireless transmitter and the wireless receiver, for the selected network based on the configuration details.

In accordance with an embodiment of the present invention, there is provided a method for supporting connection/attachment of mobile devices to a network, the method comprising: wirelessly transmitting engagement terms for reception by mobile devices, the engagement terms associated with one or more networks operating in a vicinity of the mobile devices; wirelessly receiving, from one of the mobile devices, a request for configuration details associated with a selected network of the one or more networks; and wirelessly transmitting, for reception by said one of the mobile devices, configuration details in response to the request, the configuration details for use in configuring the mobile device for connecting/attaching the mobile device to the selected network.

In accordance with an embodiment of the present invention, there is provided an apparatus for supporting connection/attachment of mobile devices to a network, the apparatus comprising: an access node configured to wirelessly communicate with mobile devices; an information server configured to provide engagement terms for wireless transmission to a set of mobile devices via the access node, the engagement terms associated with one or more networks operating in a vicinity of the mobile devices; and a configuration server configured to: receive a request for configuration details associated with a selected network of the one or more networks, the request received from a mobile device of the set of mobile devices via the access node; and provide, for wireless transmission to said one of the mobile devices via the access node, configuration details in response to the request, the configuration details for use in configuring the mobile device for connecting/attaching the mobile device to the selected network.

In accordance with an embodiment of the present invention, there is provided a system comprising: a mobile device comprising a wireless transmitter, a wireless receiver, a microprocessor, and a memory and configured to: receive, using the wireless receiver, engagement terms associated with one or more available networks in a vicinity of the mobile device; transmit, using the wireless transmitter, a request for configuration details associated with a selected network of the available networks; receive, using the wireless receiver, configuration details transmitted in response to the request, the configuration details for use in configuring the mobile device for connecting/attaching the mobile device to the selected network; and initiate a registration and connection operation, using the wireless transmitter and the wireless receiver, for the selected network based on the configuration details; and an apparatus for supporting connection/attachment of the mobile device to a network, the apparatus comprising: an access node configured to wirelessly communicate with the mobile device; an information server configured to provide the engagement terms for wireless transmission to the mobile device via the access node; and a configuration server configured to: receive the request for configuration details from the mobile device via the access node; and provide, for wireless transmission to the mobile device via the access node, the configuration details in response to the request.

### BRIEF DESCRIPTION OF THE FIGURES

Further features and advantages of the present invention will become apparent from the following detailed description, taken in combination with the appended drawings, in which:

FIG. 1 illustrates a method for connecting/attaching a mobile device to a network, according to an embodiment of the present invention.

FIG. 2 illustrates a method for supporting connection/attachment of mobile devices to a network, according to an embodiment of the present invention.

FIG. 3 illustrates a mobile device and supporting apparatus provided in accordance with an embodiment of the present invention.

FIG. 4 illustrates operations performed by a mobile device in accordance with an embodiment of the present invention.

FIG. 5A illustrates components of a mobile device and supporting apparatus, according to an embodiment of the present invention.

FIG. 5B illustrates components of a mobile device and supporting apparatus, according to another embodiment of the present invention.

FIG. 6 illustrates communication operations between a mobile device and access node, according to an embodiment of the present invention.

It will be noted that throughout the appended drawings, like features are identified by like reference numerals.

### DETAILED DESCRIPTION

As used herein, the terms “User Equipment” (UE) and “mobile device” are used to refer to one of a variety of devices, such as a consumer or machine-type device, which communicates with an access node via wireless communication. One skilled in the art will appreciate that a mobile device is a device designed to connect to a mobile network. This connection typically makes use of a wireless connection to an access node or access point. Although the mobile network is designed to support mobility, it is not necessary that the mobile device itself be mobile. Some mobile devices, such as metering devices (e.g., smart meters) may not be capable of mobility, but still make use of the mobile network.

As used herein, a “network” or “communication network” or “mobile network” may radio provide communication services to various devices including but not necessarily limited to mobile devices. A mobile device can communicate with radio nodes of the communication network using a predetermined protocol and have such communications routed to a designated destination. Such a network may include a radio access portion and backhaul portion. The network may further comprise various virtualized components as will become readily apparent herein. A primary example of such a network is a 5th generation (5G) mobile network, for example as defined by the Next Generation Mobile Networks Alliance.

As used herein, network slicing refers to a technique for separating different types of network traffic which can be used in reconfigurable network architectures, such as networks employing network function virtualization (NFV). For example, a network slice (as defined in 3GPP TR 22.891 entitled “Study on New Services and Markets Technology Enablers,” Release 14, Version 1.2.0, Jan. 20, 2016) may be a logical construct in which computing and communication resources are used to support a collection of logical network functions that supports the communication service requirements of particular use cases.

As used herein, the term “OSS” is used to refer to Operations Support Systems, which are software (and sometimes hardware) systems that support back-office activities for operation of a network and provision of customer services.

As used herein, the term “BSS” is used to refer to Business Support Systems, which are software applications that support customer-facing activities associated with a network, such as, but not limited to billing, order management, customer relationship management, and call centre automation.

Embodiments of the present invention provide a method and apparatus which allows a mobile device, such as a UE, to select one of several available networks to connect/attach to, and to reconfigure itself to operate with the selected network. The selection may be based on engagement terms (e.g. including availability, pricing, service plans, etc.) offered by the networks. The engagement terms may be wirelessly received from mobile networks in a vicinity of the mobile device, for example via wireless transmissions (broadcast, multicast or unicast) from access nodes of the mobile networks. The engagement terms can alternatively be referred to as service terms, parameters or information, or engagement parameters or information. The reconfiguration can include configuring or reconfiguring credentials of the mobile device, such as core identity information found in a SIM, in order to interoperate with the selected network. The mobile device may request configuration details, including the credentials, via a message wirelessly transmitted to a selected network, and the configuration details can be transmitted in response to the request. The credentials can be stored in an authentication storage module of the mobile device. Concurrently, the selected network may be reconfigured to register the credentials so as to accommodate the mobile device. Selection and configuration may be carried out via wireless communication, in which the mobile device receives one or more offers or bids from available networks and selects a network with which to operate.

This approach can allow greater freedom in the selection of a subscription. The mobile device can be permitted to subscribe to more than one network, either concurrently or sequentially.

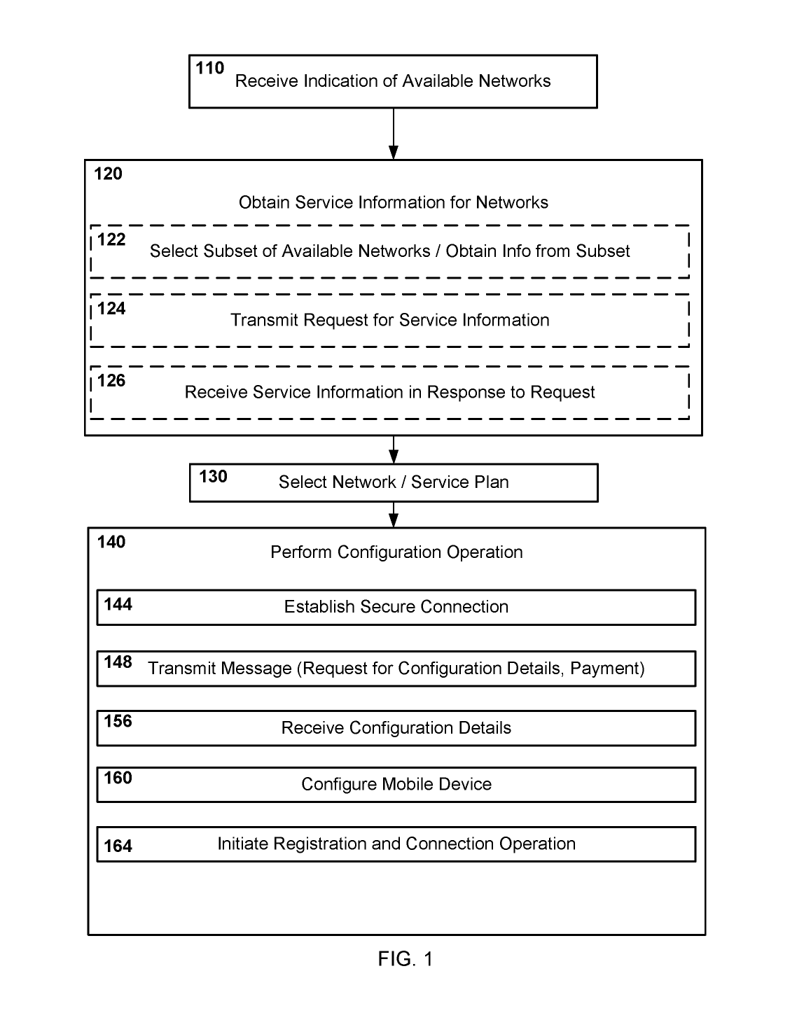

Embodiments of the present invention provide for a mobile device which is reconfigurable for attaching to a selected mobile network. Having reference to FIG. 1, the mobile device is configured to receive 110 an indication of available networks to which the mobile device can connect. The mobile device is further configured to obtain 120 engagement terms for some or all of the available mobile networks. It will be well understood that this can be performed using a variety of network interfaces, including through receipt of this message through a transmission received wirelessly from a network access node (e.g. a base station, eNodeB, or equivalent). The obtained engagement terms can include rate plans and explanations of the different levels of service associated with the different rate planes. These engagement terms can also include information about coverage and limitations in service. The mobile device can be further configured to select 130 one of the available mobile networks and/or a service plan offered thereby. The selection may be performed automatically based on stored preferences, or the selection may involve prompting for and receiving user input via a user interface associated with the mobile device, the user input indicative of the selection. The mobile device can be further configured to execute 140 a configuration operation so that it is configured to attach to the selected mobile network.

Other embodiments of the present invention provide for a method for execution by a mobile device, the method comprising performing the operations generally described with respect to FIG. 1 and elsewhere herein. Operations performed by the mobile device may be directed by execution of program instructions, stored in memory, by a microprocessor of the mobile device (or other suitable processing hardware), and by operation of other components of the mobile device, such as a user interface, wireless transmitter and wireless receiver, under direction of the microprocessor, as would be readily understood by a worker skilled in the art.

Receiving 110 the indication of available networks may comprise scanning the wireless environment using the wireless receiver of the mobile device. As will be readily understood by a worker skilled in the art, mobile networks typically broadcast messages indicating their identity and availability. The configuration of the broadcast messages for LTE networks is defined by the Third Generation Partnership Project (3GPP), while other network types will be such messages defined in the analogous standards. Scanning the wireless environment comprises monitoring for, receiving and decoding such broadcast messages. A list of available networks can be compiled from the received and decoded broadcast messages.

In some embodiments, the mobile device is configured to determine whether the mobile device is already associated with (e.g. there is a paid subscription to) one of the available networks, and, if so, whether the mobile device is to connect to such a network. If so, the operations of obtaining 120 engagement terms, selecting 130 the network and/or service plan, and several parts of the configuration operation 140 may be omitted, and the mobile device instead skips ahead to one of the sub-operations of the configuration operation 140, such as registering with the network 164. Otherwise, when the mobile device is not connecting to an already-associated network, the operations 120, 130, 140 are performed as described in more detail below.

Obtaining 120 engagement terms for mobile networks may comprise wirelessly receiving the engagement terms. Some or all of the wirelessly received engagement terms may be associated with available mobile networks in a vicinity of the mobile device. In some embodiments, each mobile network wirelessly transmits its own engagement terms for receipt by the mobile device. In some embodiments, an apparatus (for example belonging to a mobile network) is configured to transmit engagement terms for one or a plurality of mobile networks. Wirelessly receiving the engagement terms may include wirelessly monitoring for broadcast signals indicative of the engagement terms. Such broadcast signals may be provided without a specific request required.

In some embodiments, the mobile device is configured to select 122 a subset of the available networks and obtain engagement terms only for the selected subset. The selection may be performed automatically based on stored preferences or based on user input. As such, less desirable networks can be eliminated from consideration early on, thereby conserving communication, computing and power resources. In some embodiments, the mobile device obtains engagement terms only for one available network at a time (i.e. the subset includes only one network).

In some embodiments, the mobile device is configured to transmit 124 a request for engagement terms to one or more networks and/or apparatuses having access to such engagement terms. The engagement terms are transmitted to and wirelessly received 126 by the mobile device in response to the request. The request or requests may be transmitted following wirelessly monitoring for broadcast signals indicative of availability of a set of mobile networks (including one or more available mobile networks to which the requests for engagement terms are wirelessly transmitted to).

In some embodiments, the engagement terms are broadcast periodically, for example along with the broadcast information indicative of network identity and availability, or in a separate broadcast message. In this case, obtaining the engagement terms may comprise wirelessly receiving 126 the engagement terms by monitoring for, receiving and decoding such broadcast messages. In some embodiments, receiving 110 the indication of available networks and obtaining 120 the engagement terms may be integrated together. For example, the mobile device may scan for, receive and decode broadcasts which indicate both the availability of a network and the engagement terms for that network.

The obtained engagement terms for a mobile network may include details such as one or more of: the network operator's name or an identifier of the network, available service plans, pricing information, scope of network coverage, network type, network speed, temporal and geographic coverage and/or limitations, etc. The engagement terms may implicitly indicate availability of the network by broadcasting the engagement terms using the network's access nodes. The engagement terms may explicitly indicate geographic information related to network coverage. In addition to basic availability, the engagement terms can include an indication of the available service plans being offered by the network operator in association with the network. Available service plans can include both long term plans (e.g., a recurring monthly plan) and short term plans (e.g., a daily plan or a plan limited by usage). Service plans can specify a pricing scheme for voice and/or data services and other charges associated with the plan. A given mobile network may offer one or multiple service plans. A service plan may provide a specified level of service according to a specified pricing structure. The service may include communication services, cloud-based services, media services, and the like, as would be readily understood by a worker skilled in the art.

In some embodiments, the mobile device may be configured to negotiate a desired service plan based on the received information. For example, the request for engagement terms may include a proposal for a desired level and/or quality of service along with an associated pricing scheme or rate plan. The response to the request may indicate whether this proposal is accepted or the response may include a counter-offer. The process of transmitting 124 the request and receiving 126 a response to the request may be repeated in order to carry out the negotiation.

Selecting 130 a mobile network and/or service plan comprises determining whether an available service plan is accepted by the user or owner of the mobile device. When multiple service plans are under consideration, one (or possibly more than one) of the service plans may be accepted. In some embodiments, the selection is performed automatically based on stored preferences. In some embodiments, the selection comprises providing details to a user or authorized individual, for example via a user interface of the mobile device, and receiving input from the user (e.g. via the user interface) of which service plan is accepted.

The configuration operation 140 may comprise establishing 144 a secure connection between the mobile device and a configuration server associated with the selected mobile network. The secure connection is then used to communicate sensitive information such as payment details and mobile device configuration details. In one embodiment, the secure connection can be established using techniques such as Transport Layer Security (TLS). The configuration server may be located at an access node of the mobile network, in a core network portion of the mobile network, or external to but communicatively coupled to the mobile network.

The configuration operation 140 further comprises transmitting 148 a message from the mobile device to the configuration server associated with a selected network. The message comprises or represents a request for configuration details associated with the selected network. The message also implicitly or explicitly comprises or represents a request to enter into a service arrangement with the selected network according to a default or selected service plan. The message may comprise an indication of the service plan, if required. The message may further comprise details such as payment or billing information, a confirmation of identity of the user such as account details, name and address information, a photograph of the user, a photograph of the user's driver's license or passport, etc. If a photograph is required, the mobile device may be configured to automatically prompt for, capture and upload the appropriate photograph, for example using a built-in camera. The transmitted message may be transmitted as a single message or broken into multiple messages.

The configuration operation 140 further comprises receiving 156 configuration details for use in configuring the mobile device for connecting/attaching the mobile device to the selected network. The configuration details may be transmitted to the mobile device via a secure wireless message or messages. If the configuration details are not stored in the mobile device, they may be wirelessly received by the mobile device from the configuration server. Alternatively, if the configuration details are stored in memory of the mobile device, they may be retrieved from memory.

The configuration details may include a network identifier indicative of the selected mobile network and identification information uniquely associated with the mobile device and usable for registering the mobile device with the selected mobile network. The identification information may include data which can be stored in an authentication storage module of the mobile device, such as a programmable SIM or virtual SIM. Such data may include, for example, an international mobile subscriber identity (IMSI), a shared secret to allow the UE and network to engage in authentication challenges, and an operator code indicative of a registered identity of the operator. The selected network is programmed to accept registration and connection of the mobile device upon use of the identification information by the mobile device. In some embodiments, the programming is performed as part of the configuration operation.

The configuration details may include such identifying information as is necessary to register the mobile device with the selected mobile network. In some embodiments, this identifying information comprises new and possibly temporary contact information, such as a phone number and/or IMSI. In some embodiments, a pre-existing phone number and/or IMSI of the user may be retained, if possible.

The configuration operation 140 further comprises configuring 160 the mobile device using the received configuration details. In particular, an authentication storage module can be programmed in accordance with the configuration details, including storing the identification information therein. Programming may comprise storing identification information in memory, configuring encryption and/or authentication routines performed by the authentication storage module.

In some embodiments, the configuration details comprise mobile device configuration information specific to the communication protocols supported by the selected mobile network. The mobile device can therefore be configured to operate in accordance with these communication protocols.

The configuration operation 140 further comprises initiating a registration and connection operation 164 by the configured mobile device, to in order to register and connect with the selected network. Because the mobile device has been configured particularly for operation with the selected network, the registration and connection operation can proceed according to the standard protocols established for the selected network. Such protocols depend on the type of network and would be readily understood by a worker skilled in the art. For example, the network identifier specified in the configuration details may be used to address the selected network to initiate registration therewith. The registration and connection operation can be initiated by transmitting a connection request to an access node of the selected network, for example.

In some embodiments, if a connection fails to be made with a mobile network from the selected subset, a different subset of available networks can be selected 122 and the above procedure can be repeated.

It is noted that, if the operation of selecting 130 a mobile network and/or service plan, or the configuration operation 140 fails, a new subset of available networks can be selected 122 and the procedure repeated.

Embodiments of the present invention provide for an apparatus configured to interact with a mobile device via wireless communication to facilitate connection/attachment of the mobile device to a mobile network. The apparatus may reside in a mobile network and comprise one or more computing and/or communication devices within the core network portion and/or edge network portion of the mobile network. The apparatus may comprise an access node, an information server and a configuration server. These servers may be separate or integrated into a single server. In some embodiments, one or both of the servers are integrated with the access node. In some embodiments, one or both of the servers are located in a core network or another location communicatively coupled to the access node. An exemplary server comprises a processor, a memory, and a network communication interface operatively coupled to the access node, which is generally a networked device comprising a wireless transmitter/receiver configured to wirelessly communicate with mobile devices. The access node may be a base station, wireless access point, eNB, or the like, for example. The reception and transmission of wireless messages by and from the servers may be performed via the access node or other wireless transmitter/receiver to which the servers are connected.

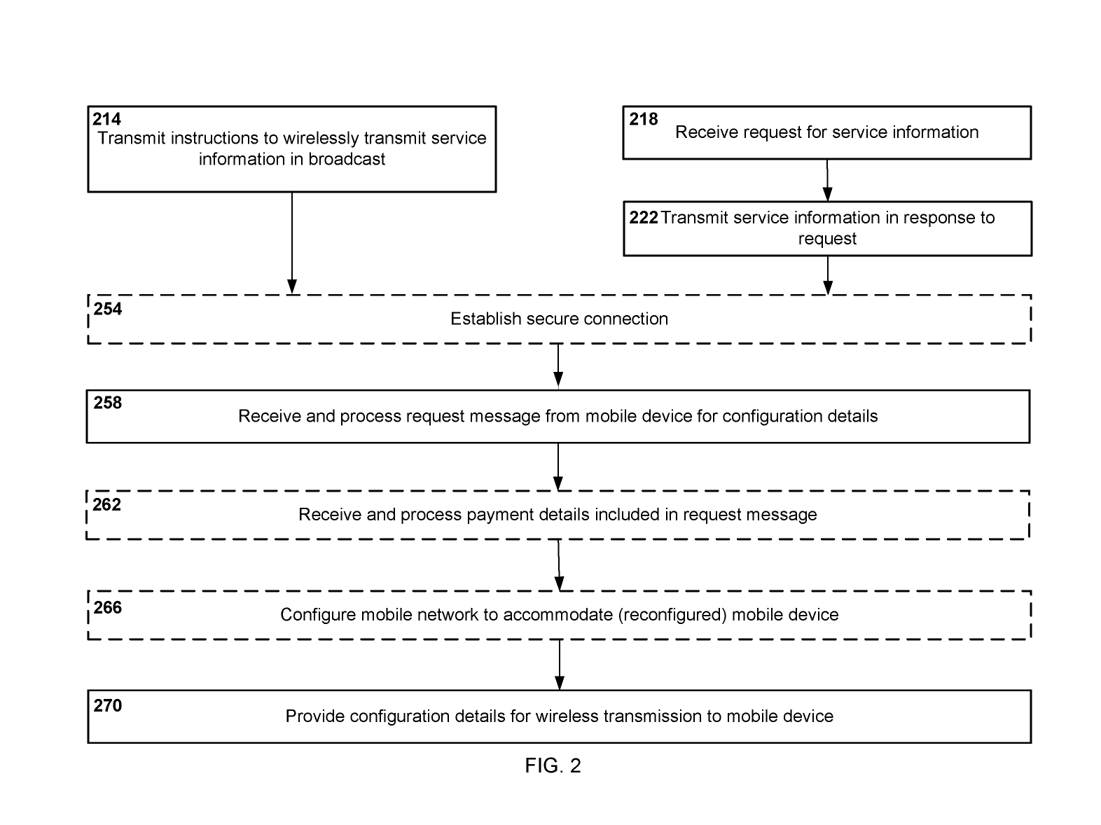

Having reference to FIG. 2, the information server is configured to provide engagement terms for wireless transmission to mobile devices, as described above. In some embodiments, the information server transmits 214 instructions, for example to an access node, to wirelessly transmit the engagement terms as part of periodically broadcast information. In some embodiments, the information server receives 218 a request from a mobile device for the engagement terms, and transmits 222 the engagement terms to the mobile device (via the access node) in response to the request. The information server may be configured to negotiate with the mobile device via repeated communications therewith. A memory of the information server stores the engagement terms and/or parameters for negotiating services with mobile devices.

The configuration server and/or another security device of the mobile network is configured to establish 254 a secure connection with the mobile device for communicating (via the access node) during the configuration operation. The configuration server is further configured to receive and process 258 request messages from the mobile device corresponding to requests for configuration details associated with a selected network. The request may correspond to a request to enter into a service arrangement with the mobile network according to a service plan.

The configuration server may further receive and process 262 payment details included in the request messages, such as payment or billing information, a confirmation of identity of the user such as account details, name and address information, a photograph of the user, a photograph of the user's driver's license or passport, etc. In one embodiment, photographs are forwarded to a human operator for verification. The configuration server may further be configured, in response to such request messages, to configure 266 the mobile network to accommodate the mobile device according to the specified service plan, for example after payment has been processed.

In more detail, in some embodiments, the confirmation of identity of a user may be obtained as follows. An apparatus in the network, such as the configuration server (or information server) transmits a request to the mobile device to provide a confirmation of user identity. The mobile device then forwards a stored confirmation of identity or prompts the user to provide the confirmation of identity via a user interface. The confirmation of identity may be a photograph of the user or the user's passport, as mentioned above, or another acceptable type of confirmation. A message indicative of the confirmation of identity is then wirelessly transmitted to the apparatus, for example over a secure channel.

Upon satisfactory processing of a request message, the configuration server responds by providing 270 configuration details for wireless transmission to said one of the mobile devices via the access node. The configuration details are used for to configure the mobile device for connecting/attaching the mobile device to the selected network. Configuration 266 of the mobile network may comprise adjusting one or more nodes of the network to register a mobile device presenting credentials matching those of the transmitted configuration details.

In various embodiments, the apparatus is further configured to perform or support registration and connection of a mobile device to the selected network upon receipt of a message from the mobile device for initiating a registration and connection operation. The message is transmitted by the mobile device following configuration of the mobile device based on the configuration details. The apparatus may include appropriate registration and connection infrastructure devices, such as core network and edge network devices, for this purpose, as would be readily understood by a worker skilled in the art.

In one embodiment, the apparatus comprises, or is operatively coupled to or integrated with, an access node of the mobile network. The access node, under direction of the apparatus, broadcasts information for receipt by the mobile device and communicates with the mobile device on behalf of the information server and the configuration server.

In some embodiments, the apparatus resides in the mobile network to which the mobile device is potentially attaching. In some embodiments, the apparatus resides in a different mobile network than the mobile network to which the mobile device is potentially attaching. In the latter case, the apparatus may obtain and advertise the availability and engagement terms of the other mobile network on behalf thereof. The apparatus may then direct the mobile device to connect/attach to the other mobile network by providing the appropriate attachment information to the mobile device. Alternatively, the apparatus may direct the mobile device to connect/attach to the network in which the apparatus resides, whereupon a handover procedure occurs which connects the mobile device to the other mobile network.

Other embodiments of the present invention provide for a method for execution by an apparatus for facilitating connection/attachment of a mobile device to a mobile network, the method comprising performing the operations generally described with respect to FIG. 2 and elsewhere herein. Operations performed by the apparatus may be directed by execution of program instructions, stored in memory, by a microprocessor of the apparatus (or other suitable processing hardware), and by operation of other components of the apparatus, such as a wireless transmitter and wireless receiver of the associated access node, under direction of the microprocessor, as would be readily understood by a worker skilled in the art.

In some embodiments, two or more mobile networks, to which the mobile device can potentially connect, are physically separate from one another. That is, each of the mobile networks comprises different devices such as access nodes and core network nodes. In some embodiments, two or more mobile networks share some or all of a common infrastructure. For example, the two or more mobile networks may be instantiated as substantially self-contained virtual mobile networks operating on a set of host hardware devices using techniques such as network slicing. Different mobile networks may be administered by the same entities (e.g. mobile network operators) or by different entities. An apparatus for facilitating connection/attachment of a mobile device to a first network may reside in a second, different network.

Embodiments of the present invention provide for a system comprising one or more of the above-described apparatuses, residing in one or more mobile networks and configured to facilitate connection/attachment of mobile devices to mobile networks, and one or more of the above-described mobile devices which is reconfigurable for connecting/attaching to a selected one of the one or more mobile networks. Embodiments of the present invention provide for a corresponding method for facilitating connection/attachment of mobile devices to mobile networks, the method comprising operations performed by both mobile devices and apparatuses communicatively coupled thereto.

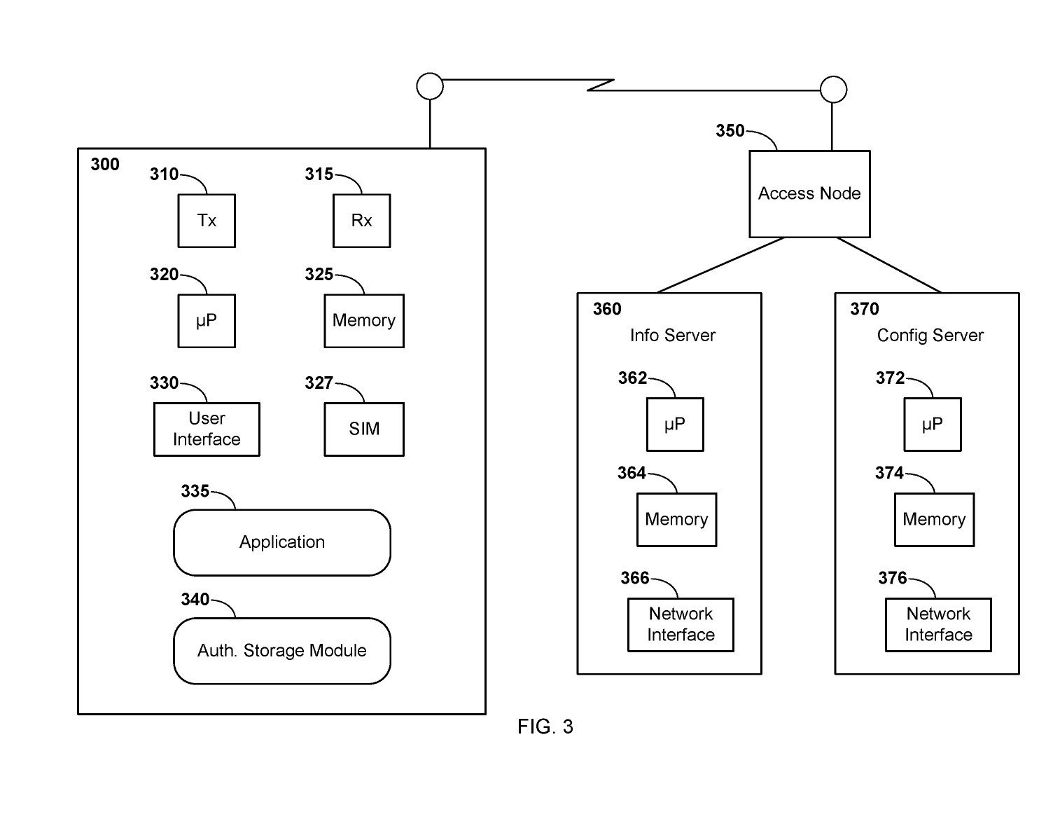

FIG. 3 illustrates a mobile device 300 and an apparatus configured to facilitate connection/attachment of the mobile device 300 to a mobile network, according to an embodiment of the present invention. The apparatus comprises an access node 350, a configuration server 360 and an information server 370, which may be at least partially integrated together or provided as separate devices. The mobile device 300 comprises a wireless transmitter 310, a wireless receiver 315, a microprocessor 320, a memory 325 and a user interface 330. The memory 325 stores program instructions for execution by the microprocessor as well as data to be stored by the mobile device. The memory 325 can be provided as one or more separate memory components. The wireless transmitter, receiver, microprocessor, memory and user interface interoperate as would be readily understood by a worker skilled in the art. The microprocessor and memory may be configured to provide and execute an application 335 which configures the mobile device and interacts with a user via the user interface as described herein. A SIM 327 may also be provided in some embodiments. The microprocessor 320 and memory 325, and/or the SIM 327, may be configured to provide an authentication storage module 340, which stores identifier information for use in connecting to and authenticating with a subscription-based network, and which is reprogrammable with new identifier information after deployment of the mobile device. The authentication storage module may be a virtual SIM, a reprogrammable SIM such as a removable SIM card, or the like.

The mobile device 300 communicates with the access node 350 via its wireless transmitter and wireless receiver. The access node may be a base station, access point, evolved NodeB, or other device implementing a wireless transmitter and receiver and configured to communicate with the mobile device 300. The access node 350 communicates via a network interface, if required, with the information server 360 and configuration server 370. It is again noted that the information server 360 and the configuration server 370 may be real or virtual servers, or aspects of other devices within the edge network or core network of a wireless communication network, within network slices, or at other locations in communication with the access node via the wireless communication network, for example via a gateway.

The information server 360 comprises a microprocessor 362, a memory 364, and a network interface 366. The information server is configured, via program instructions store in memory 364, to perform operations such as but not necessarily limited to providing engagement terms to mobile devices via the access node 350.

The configuration server 370 comprises a microprocessor 372, a memory 374, and a network interface 376. The configuration server is configured, via program instructions store in memory 374, to perform operations such as but not necessarily limited to providing configuration details to mobile devices via the access node 350.

The following implementation details describe operation of the present invention according to certain embodiments and examples.

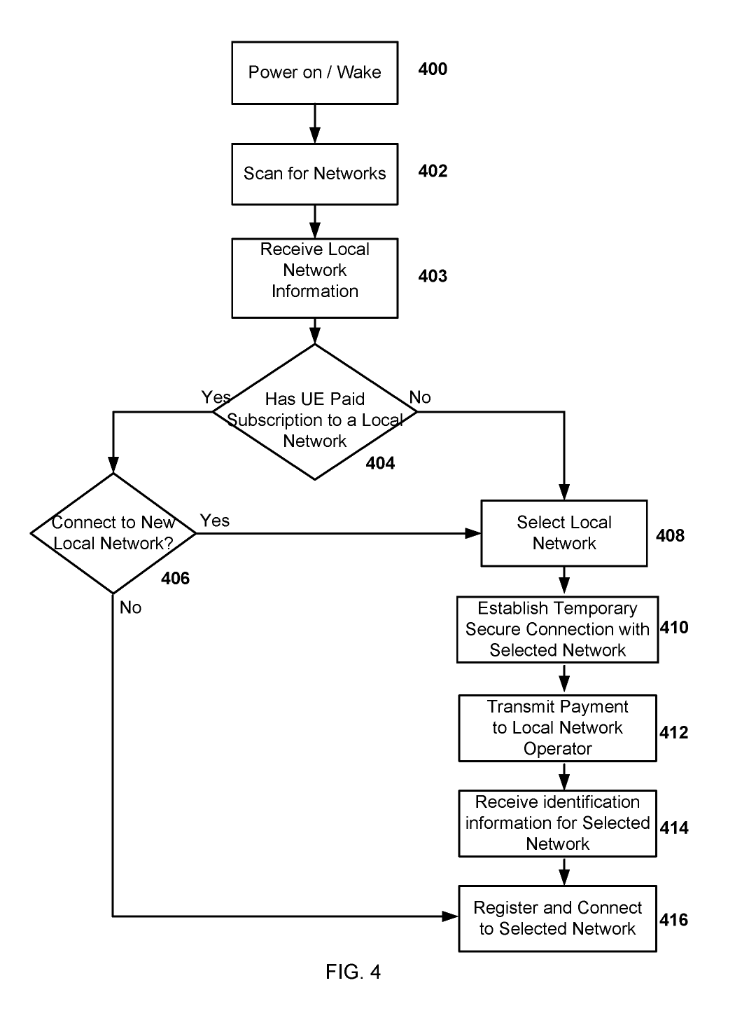

FIG. 4 schematically depicts operations included in one embodiment of the present system and method. As shown in FIG. 4, a mobile device scans 402 for the available mobile networks. The scan can be performed at power-on 400 or after waking from a sleep mode, for example. Information regarding locally available mobile networks is received 403 by the mobile device. Following the scan, the mobile device queries whether a plan for accessing one of the local mobile networks has already been purchased 404. If so, the mobile device can determine 406 whether to automatically connect to a new network or to connect to the network for which a plan has already been purchased. Alternatively, the user can elect to purchase a new plan and provide input to the mobile device to initiate such an action, or the mobile device may determine that no plan for access to a local network has yet been purchased. If no plan has yet been purchased, or if the user elects not to use the previously purchased plan, the user will decide whether or not to purchase a plan from a local operator. Otherwise, the mobile device may proceed to a registration and connection operation 416 for connecting to the network for which a plan has already been purchased. After obtaining and reviewing engagement terms indicating details of available service plans, the mobile device (automatically or based on user input) can select 408 a plan from an operator and proceed to payment. In one example, temporary network access is established 410 for the purpose of transmitting the payment 412. Alternatively, a separate network slice can be created for the purpose of selling mobile plans. Payment can be completed with either a credit card or other methods such as using a mobile payment application (“app”). In some embodiments, the temporary network access or separate network slice may also be used for providing and negotiating engagement terms. Service plan details may additionally or alternatively be obtained during the scan 402.

Once payment succeeds, the mobile device receives identification information 414 valid for the duration of the mobile plan. Following successful payment, a registration and connection (attachment) 416 operation is performed to provide the user access to the mobile network for the duration of the purchased plan.

In one embodiment, when the mobile device returns to the area where the plan is available after leaving that area, the mobile device can automatically (or based on user input) initiate connection to the mobile network with which it holds valid service plan. However, in order to maintain the service of a selected quality, a mobile device may be operated to purchase multiple service plans from multiple network operators. The mobile device can then receive user input indicative of which plan is to be used at a given time. For example, the mobile device may be configured to access a network administered by operator X according to a long term plan. However, in an area where both operator X and operator Y are available, operator Y can provide better service (e.g., stronger signal), the user may decide to buy a short term plan (e.g., daily) from Y and the mobile device may be configured to use the plan from operator Y instead of from operator X in this area.

Besides providing temporary network access or a dedicated network slice for providing engagement terms and facilitating configuration operations, other types of network connectivity such as Wi-Fi™ or wireline network can also be used to purchase access to a given network. For example, a mobile device may be configured to use a Wi-Fi™ connection to purchase mobile plans and receive identification information for network access. This alternative can be useful, for example, for purchasing access to a network in a given location prior to travel to that location.

It will be understood that in some embodiments, the operations outlined in FIG. 4 are modified, so that a mobile device when powering on will attempt to connect to a list of networks for which it already has identification information. If the mobile device fails to connect to any of the previously known networks, the mobile device can then scan for networks, as shown in operation 402, then proceed to operations 403 and then to operation 408.

The following description provides three, non-limiting options for configuring (e.g. programming) the authentication storage module of a mobile device, according to embodiments of the present invention.

In a first option for configuring the authentication storage module, the authentication storage module is provided as a SIM card, preinstalled in the mobile device, that holds no operator specific data and can be programmed on demand or dynamically by the mobile device itself. The identification information received from an operator after a successful payment as described above, are the same as those stored in a physical SIM card according to a standard such as LTE. For example, the identification information can include IMSI, a shared secret, and an operator code (derived from a value unique to each operator).

In various embodiments, according to the first option, the SIM card is a universal SIM card that can be reprogrammed by the mobile device itself. The mobile device may have a secure function that allows for the programming of the SIM to be done such that networks can be assured of a reduced possibility of device cloning.

In a second option for configuring the authentication storage module, the authentication storage module is provided as a virtual SIM maintained by the mobile device. The virtual SIM is configured to store identification information received during the configuration operation. Such a virtual SIM typically provides at least the same or a comparable level of security as a physical SIM card and, as above, is capable of being reprogrammed by the mobile device itself with security guarantee. The virtual SIM may be provided as a secure process operating on a microprocessor of the mobile device and having program and identification elements stored in memory of the mobile device.

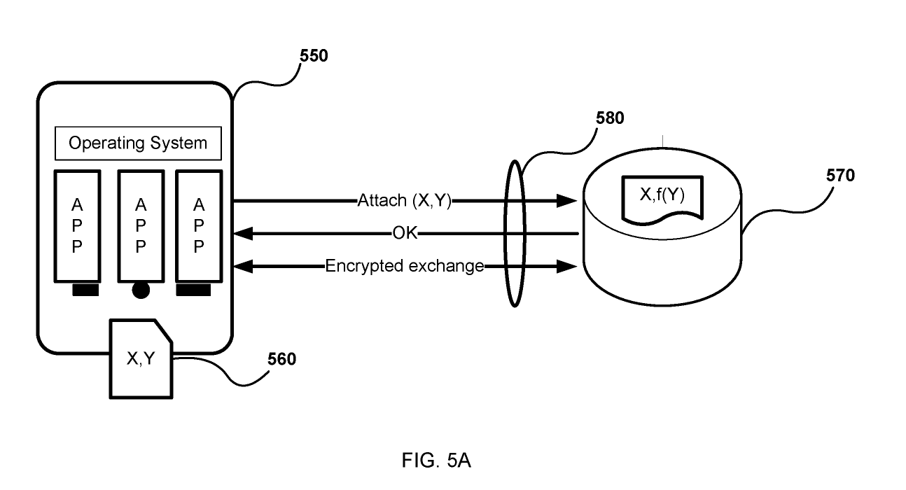

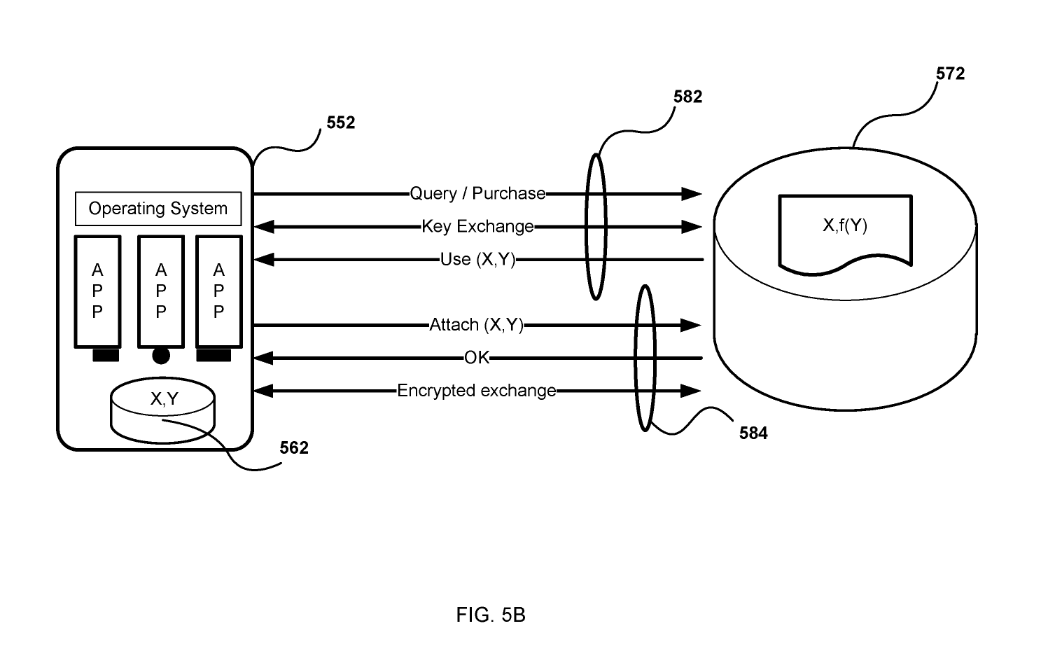

FIGS. 5A and 5B provide a comparison between an embodiment of the present invention employing a physical SIM card (FIG. 5A) to an example of another embodiment employing a virtual SIM card (FIG. 5B).

As shown in FIG. 5A, the mobile device 550 accommodates a physical SIM card 560, which carries identity X and proof of identity Y. A database 570, for example associated with a home subscriber server (HSS), is programmed with identity X and a hash function, F(Y), that allows the HSS and mobile device to exchange identity information without exposing the actual identity information. When connecting with a network via network slice 580, the mobile device 550 transmits X and Y to database 570, X and Y are authenticated and an authentication signal is sent to mobile device 500. X and Y may be transmitted in a secure (e.g. encrypted) manner. In this situation, the operator may be required to manufacture (or purchase), program and distribute SIMs, and pre-program their databases 570 with the SIM values. The cost associated with this process is not trivial and the system is relatively inflexible for users and/or operator. This may pose logistical challenges with this approach, particularly when used for mobile devices enabling the Internet of Things (IoT).

FIG. 5B schematically depicts an alternate scenario in which the mobile device 552 comprises a virtual SIM, or alternatively a reprogrammable SIM (e.g. a SIM card). In this example, SIM data (i.e. identification information) is provided to the mobile device by a configuration server (not illustrated), for example residing in a network control slice 582 after the mobile device 552 transmits a query for purchase of a plan for accessing the operator's network. The network control slice 582 is a network slice which is instantiated for the purpose of performing at least the configuration operations. The device identity data for storage in a SIM can be retrieved from a database of assignable device identity data, for example, or generated as required. A secure connection is established to allow communication between the mobile device and the network. The device identity data is transmitted to the mobile device 552 from the configuration server and/or network control slice 582, for example following receipt of payment from the user to the operator. Payment may be made through an appropriate application installed on mobile device 552. The mobile device 552 then programs itself to store the received device identity data in an authentication storage module 562. The device identity data is also added by the network to a database 572 (e.g. HSS database associated with a HSS) to allow future authentication of mobile device 552 in the network. The mobile device 552 then uses the stored device identity data in the same way it would use device identity data stored in a physical SIM to attach to the network, for example as provided by the network slice 584.

Potential advantages associated with this embodiment is that there is no requirement for the operator to manage SIMs, and that a single mobile device can support a plurality of device identity data as required so that the user no longer needs to carry multiple SIM cards for different networks. In terms of security, this alternative still permits locking of the device identity data to prevent use by others.

In a third option for configuring the authentication storage module, a public key-based approach is utilized. The use of shared secrets, as presently used in LTE, may not be an ideal option for authenticating mobile devices and/or users in association with the present invention, since this would require a unique secret to be shared with each and every mobile device and/or user. This would result in a significantly large number of shared secrets stored in the HSS, which significantly impacts key management overheads. Security risk is also high if an unauthorized access to the HSS containing shared secrets occurs. Accordingly a public key-based approach can be utilized in embodiments of the present invention, and may be preferable in some instances.

According to the public key-based approach, the mobile device comprises an authentication storage module that can be reprogrammed by a mobile device itself with a security guarantee. The authentication storage module may be SIM-less. The mobile device may reprogram the authentication storage module following receipt of a public key from the network operator after successful payment. Such a system may be configured to make use of a public key infrastructure (PM) or another method of for secure electronic transfer of public keys. The PM may comprise a set of roles, policies and procedures employed to create, manage, distribute, use, store and revoke digital certificates and manage public-key encryption. In one embodiment, the network servers may sign the data transmitted to the mobile device using a private key. The mobile device can use a public key associated with the network server (and the private key) to ensure that the received data is the same as the data transmitted (e.g. there was no tampering with the data in transit). The transmissions can also be encrypted using a public key associated with the mobile device so that third parties cannot read the transmitted instructions. The public-private key pairs and other PM infrastructure may also be used to exchange a symmetric key that is used for a single set of transactions.

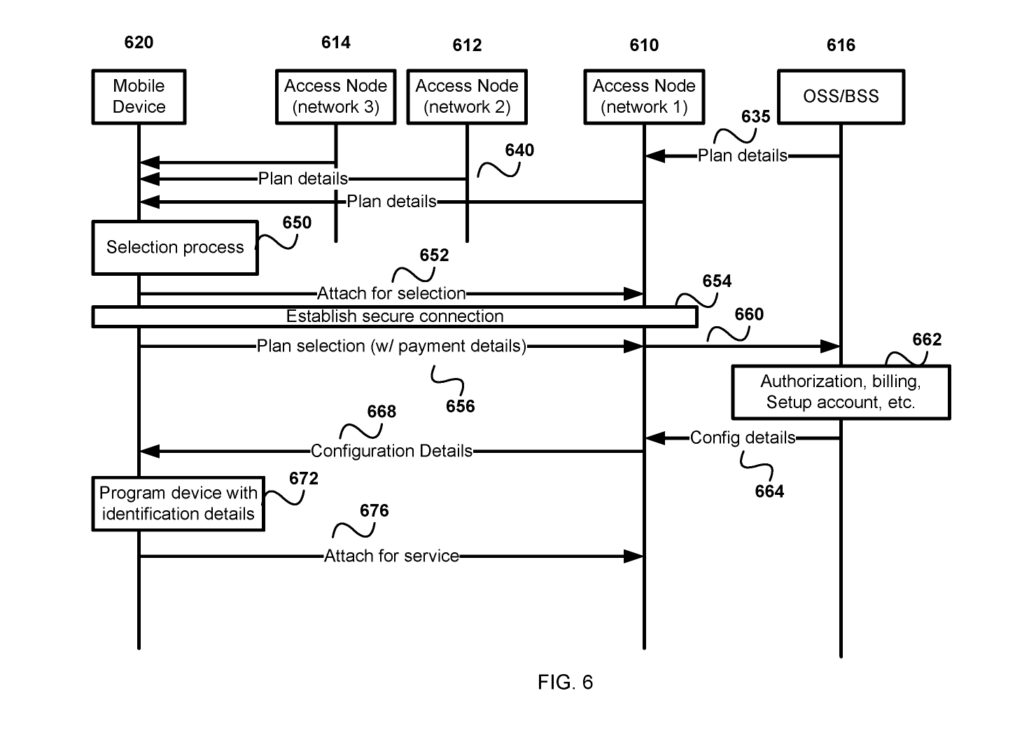

FIG. 6 provides a call flow schematic illustrating an example implementation according to an embodiment of the present invention.

With reference to FIG. 6, access nodes (ANs) 610, 612, 614 are provided with details 640 of service plans to offer. The details 640 may be previously provided 635 by one or more OSS/BSS functions 616 such as a configuration server, and other management plane or core network functions that may be viewed as network infrastructure entities. Each AN 610, 612, 614 broadcasts its service plan details 640 for receipt by mobile devices including an illustrated mobile device 620. Such operations can be performed in association with a network slice specific to the service being advertised. Each AN (or possibly only a selected subset of the ANs in the network) broadcasts the service plan details using a predetermined format readable by the mobile devices. Details of the broadcast can be included in a beacon, for example. It will also be understood that in some embodiments, a mobility management entity (MME) can perform some of the functions which might otherwise be performed by OSS/BSS entities.

The mobile device 620, when powered on, does not have a predefined network to associate with (or at least not a predefined network in this region). The mobile device 620 receives the broadcast plan details 640 from each of the ANs (610, 612, 614) from different network operators. The mobile device 620 then performs a service plan selection process 650. This may comprise displaying the engagement terms contained in the broadcast data to a user of the mobile device, and obtaining a user selection, via a user interface of the mobile device or another associated device.

With a selection made, the mobile device 620 attaches 652 to the AN (in the present example AN 610) associated with the selected plan. This attachment is performed for the purposes of selecting and subscribing to a plan and may be limited to operations supporting same. A secure connection is established 654 between mobile device 620 and the network entities. This secure connection can make use of Public Key Infrastructure (PKI) key exchange or other such techniques. Up until this point, the mobile device 620 and the network may not have a shared secret. The secure connection allows mobile device 620 and the network to exchange a shared secret that enables a secure connection to be established. This may take the form of allowing the mobile device to connect and be assigned an IP address, and then carrying out the remainder of the configuration operation using a secure protocol implemented at either a network layer or application layer. With a secure connection in place, the mobile device 620 can transmit an identification 656 of the selected plan and, optionally, also provide billing information such as credit card information. Other information such as user authentication information and photographs supporting same, can also be transmitted by the mobile device. The plan selection and billing information may be relayed 660 by the AN (610) to an infrastructure device 616, such as a configuration server and/or OSS/BSS entity, that can authorize the creation of a new user profile in the network. Upon authorizing the creation of the user profile, an instruction may be transmitted to an appropriate entity managing subscriptions to the network (e.g. a HSS) to establish an account for the mobile device. The account establishment may include registering identity information (to be used by the mobile device) with the network. The authorization, billing, account establishment, and other operations performed by the infrastructure device 616 are shown as operation 662.

Confirmation of account setup can be received by the AN 610. The configuration details 664 (e.g. network identity information details) are received by the AN 610. The AN 610 then relays 668 the configuration details to the mobile device 620.

The mobile device 620 programs itself 672 based on the received network identification information. The mobile device 620 then attaches 676 to the network for service.

In some embodiments, if the network makes use of different network slices, the mobile device 620 can attach to a different network slice than the network (e.g. network slice) that was used for providing engagement terms and/or facilitating mobile device configuration. This can result in mobile device 620 attaching to a different access point than it had attached to for the plan selection process.

In some embodiments, network slices may be instantiated on an as-needed basis for accommodating service requests of mobile devices. A network slice can be instantiated as part of the configuration operation, in order to accommodate the newly configured mobile device or set of mobile devices by the new network slice. In some embodiments, separate network slices may be instantiated for providing communication services, for providing the engagement terms to mobile devices, and/or for configuring mobile devices.

Through the descriptions of the preceding embodiments, the present invention may be implemented by using hardware only or by using software and a necessary universal hardware platform. Based on such understandings, some aspects (such as feedback control operations) of the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention. The software controlling the hardware may co-exist on the same module or it may be an external controller which reads the data and acts accordingly.

All publications, patents and patent applications mentioned in this specification are indicative of the level of skill of those skilled in the art to which this invention pertains and are herein incorporated by reference to the same extent as if each individual publication, patent, or patent applications was specifically and individually indicated to be incorporated by reference.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for connecting/attaching a mobile device to a network, the method comprising:
wirelessly receiving, by the mobile device, engagement terms associated with one or more available networks in a vicinity of the mobile device;
wirelessly transmitting, by the mobile device, a request for configuration details associated with a selected network of the available networks;
wirelessly receiving, by the mobile device, configuration details transmitted in response to the request, the configuration details for use in configuring the mobile device for connecting/attaching the mobile device to the selected network; and
initiating a registration and connection operation with the selected network based on the configuration details.

2. The method of claim 1, further comprising programming an authentication storage module of the mobile device in accordance with the configuration details prior to the registration and connection operation.

3. The method of claim 2, wherein the authentication storage module comprises one or more of: a microprocessor and a memory of the mobile device; and a reprogrammable subscriber identity module (SIM) of the mobile device.

4. The method of claim 1, wherein the configuration details comprise identification information for the mobile device, the identification information usable for registering the mobile device with the selected network, wherein the selected network is programmed to accept registration of the mobile device upon use of said identification information thereby.

5. The method of claim 1, further comprising wirelessly transmitting one or more of: an indication of a selected service plan offered in association with the selected network; and payment information for use in paying for usage of the selected network by the mobile device.

6. The method of claim 1, wherein the engagement terms are indicative of one or more of: pricing information; available service plans; network operator identity; scope of network coverage; network type; network speed; and geographic coverage.

7. A mobile device comprising a wireless transmitter, a wireless receiver, a microprocessor, and a memory and configured to:
receive, using the wireless receiver, engagement terms associated with one or more available networks in a vicinity of the mobile device;
transmit, using the wireless transmitter, a request for configuration details associated with a selected network of the available networks;
receive, using the wireless receiver, configuration details transmitted in response to the request, the configuration details for use in configuring the mobile device for connecting/attaching the mobile device to the selected network; and
initiate a registration and connection operation, using the wireless transmitter and the wireless receiver, for the selected network based on the configuration details.

8. The mobile device claim 7, further comprising an authentication storage module, the mobile device further configured to program, using the microprocessor, the authentication storage module in accordance with the configuration details prior to the registration and connection operation.

9. The mobile device of claim 8, wherein the authentication storage module comprises one or more of: the microprocessor and the memory of the mobile device; and a reprogrammable subscriber identity module (SIM) of the mobile device.

10. A method for supporting connection/attachment of mobile devices to a network, the method comprising:
wirelessly transmitting engagement terms for reception by mobile devices, the engagement terms associated with one or more networks operating in a vicinity of the mobile devices;
wirelessly receiving, from one of the mobile devices, a request for configuration details associated with a selected network of the one or more networks; and
wirelessly transmitting, for reception by said one of the mobile devices, configuration details in response to the request, the configuration details for use in configuring the mobile device for connecting/attaching the mobile device to the selected network.

11. The method of claim 10, further comprising registering and connecting said one of the mobile devices to the selected network upon reception of registration and connection communications from the mobile device following configuration of the mobile device based on the configuration details.

12. The method of claim 10, wherein the configuration details comprise identification information for the mobile device, the identification information usable for registering the mobile device with the selected network, the method further comprising programming one or more entities of the selected network to accept registration of the mobile device upon use of said identification information thereby.

13. The method of claim 10, further comprising wirelessly receiving one or more of: an indication of a selected service plan offered in association with the selected network; and payment information for use in paying for usage of the selected network by the mobile device.

14. The method of claim 10, wherein the engagement terms are indicative of one or more of: pricing information; available service plans; network operator identity; scope of network coverage; network type; network speed; and geographic coverage.

15. An apparatus for supporting connection/attachment of mobile devices to a network, the apparatus comprising:
an access node configured to wirelessly communicate with mobile devices;
an information server configured to provide engagement terms for wireless transmission to a set of mobile devices via the access node, the engagement terms associated with one or more networks operating in a vicinity of the mobile devices; and
a configuration server configured to:
receive a request for configuration details associated with a selected network of the one or more networks, the request received from a mobile device of the set of mobile devices via the access node; and
provide, for wireless transmission to said one of the mobile devices via the access node, configuration details in response to the request, the configuration details for use in configuring the mobile device for connecting/attaching the mobile device to the selected network.

16. The apparatus of claim 15, further configured to register and connect said one of the mobile devices to the selected network upon receipt of one or more messages from the mobile device for initiating a registration and connection operation, following configuration of the mobile device based on the configuration details.

17. The apparatus of claim 15, wherein the configuration details comprise identification information for the mobile device, the identification information usable for registering the mobile device with the selected network, the method further comprising programming one or more entities of the selected network to accept registration of the mobile device upon use of said identification information by the mobile device in a registration and connection operation.

18. The apparatus of claim 15, wherein the configuration server is further configured to request, receive, or both request and receive, via the access node, one or more of: an indication of a selected service plan offered in association with the selected network; and payment information for use in paying for usage of the selected network by the mobile device.

19. The apparatus of claim 15, wherein the engagement terms are indicative of one or more of: pricing information; available service plans; network operator identity;
scope of network coverage; network type; network speed; and geographic coverage.

20. A system comprising:
a mobile device comprising a wireless transmitter, a wireless receiver, a microprocessor, and a memory and configured to:
receive, using the wireless receiver, engagement terms associated with one or more available networks in a vicinity of the mobile device;
transmit, using the wireless transmitter, a request for configuration details associated with a selected network of the available networks;
receive, using the wireless receiver, configuration details transmitted in response to the request, the configuration details for use in configuring the mobile device for connecting/attaching the mobile device to the selected network; and
initiate a registration and connection operation, using the wireless transmitter and the wireless receiver, for the selected network based on the configuration details; and
an apparatus for supporting connection/attachment of the mobile device to a network, the apparatus comprising:
an access node configured to wirelessly communicate with the mobile device;
an information server configured to provide the engagement terms for wireless transmission to the mobile device via the access node; and
a configuration server configured to:
receive the request for configuration details from the mobile device via the access node; and
provide, for wireless transmission to the mobile device via the access node, the configuration details in response to the request.
